(19) United States
(12) Patent Application Publication
(10) Pub. No.: US 2004/0179354 A1
(43) Pub. Date: Sep. 16, 2004

(54) Light device having objects receiving housing

(76) Inventor: Kuo Hsin Chen, Chong Ho City (TW)

Correspondence Address: Kuo Hsin CHEN, P.O.Box 10-69, Chong Ho, Taipei, 235, TW

(21) Appl. No.: 10/390,403

(22) Filed: Mar. 12, 2003

(51) Int. Cl. F21S 8/08; F21V 33/00

(52) U.S. Cl. 362/154; 362/414

(57) ABSTRACT

A light device includes a housing having a bottom panel, a rear wall and a front wall extended up from the bottom panel to form a space in the housing and to receive various objects in the space of the housing. A support device includes a bracket secured on the rear wall, a bar and a socket disposed on top of the bracket, a frame secured on the bar and having an upper fastener. A light member is attached to the socket, and a lampshade includes an upper spider secured to the frame with the fastener. The housing may be formed into various shapes or contours, for decorative purposes, and may be used to receive various objects.

### BACKGROUND OF THE INVENTION

1. Field of the Invention

The present invention relates to a light device, and more particularly to a light device having a housing for receiving various objects.

2. Description of the Prior Art

Various kinds of typical light devices have been developed for being disposed on table top, and for lighting purposes. For example, as shown in FIG. 10, illustrated is one of the typical light devices and comprises a base 10 including a seat 12 provided thereon and having a socket 14 provided therein to receive a light member 17 therein, and a lamp shade 11 having a bracket 13 disposed therein to engage onto the light member 17.

The seat 12 and the base 10 of the typical light device is provided for supporting the light member 17 only, and may not be used to receive or store the other objects.

The present invention has arisen to mitigate and/or obviate the afore-described disadvantages of the conventional light devices.

### SUMMARY OF THE INVENTION

The primary objective of the present invention is to provide a light device including a housing for receiving or storing various objects therein.

In accordance with one aspect of the invention, there is provided a light device comprising a housing including a bottom panel, a rear wall extended up from the bottom panel, to define a space in the housing and to receive various objects in the space of the housing, a support device including a bracket secured on top of the rear wall, a bar and a socket disposed on top of the bracket, a frame secured on the bar and including an upper portion having a fastener provided thereon, a light member attached to the socket, a lamp shade including an upper portion having a spider disposed therein and secured to the upper portion of the frame with the fastener. The housing may be formed or shaped into various kinds of contours, for decorative purposes, and may be provided for receiving or storing various objects therein.

The housing further includes a front wall extended up from the bottom panel, to define the space in the housing together with the rear wall. The housing further includes at least one shelf disposed between the front wall and the rear wall, to receive the objects on the shelf.

The spider of the lampshade includes a ring provided therein and having an orifice formed therein to receive the fastener. The support device includes a lock nut threaded to the fastener and engaged with the ring to solidly secure the lampshade on the frame. The support device includes a tube attached to the bracket.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a light device in accordance with the present invention;

FIG. 2 is a perspective view of the light device;

FIG. 3 is a rear view of the light device;

FIG. 4 is a side view of the light device;

FIG. 5 is a front plan view illustrating the other embodiment of the light device;

FIG. 6 is a front plan view similar to FIG. 5, illustrating a further embodiment of the light device;

FIG. 7 is a side view of the light device as shown in FIG. 6;

FIG. 8 is a front plan view similar to FIGS. 5 and 6, illustrating a still further embodiment of the light device;

FIG. 9 is a side view of the light device as shown in FIG. 8; and

FIG. 10 is a partial exploded view illustrating a typical light device.

### DETAILED DESCRIPTION OF THE PREFERRED EMBODIMENT

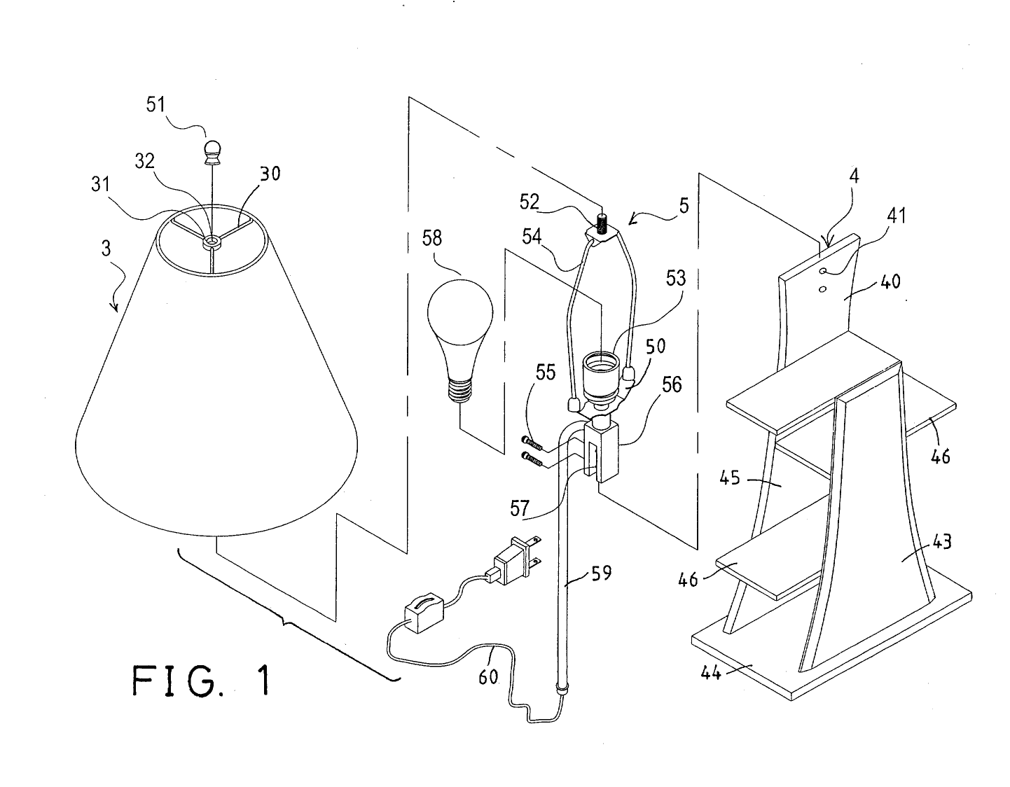

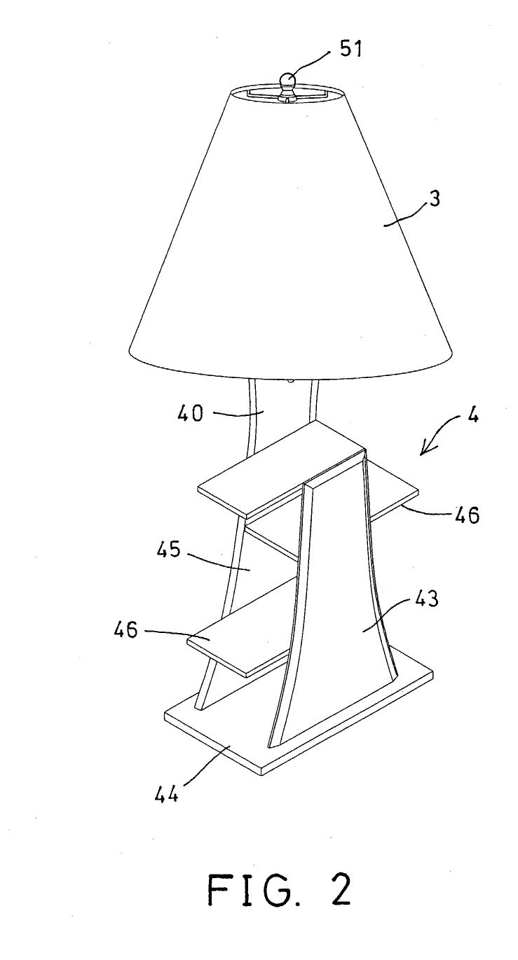

Referring to the drawings, and initially to FIGS. 1-4, a light device in accordance with the present invention comprises a lampshade 3 to be supported above a housing 4 with a support device 5. The lampshade 3 includes a spider 30 formed or provided on top thereof, and a ring 31 disposed in the middle or center portion of the spider 30 and having an orifice 32 formed therein.

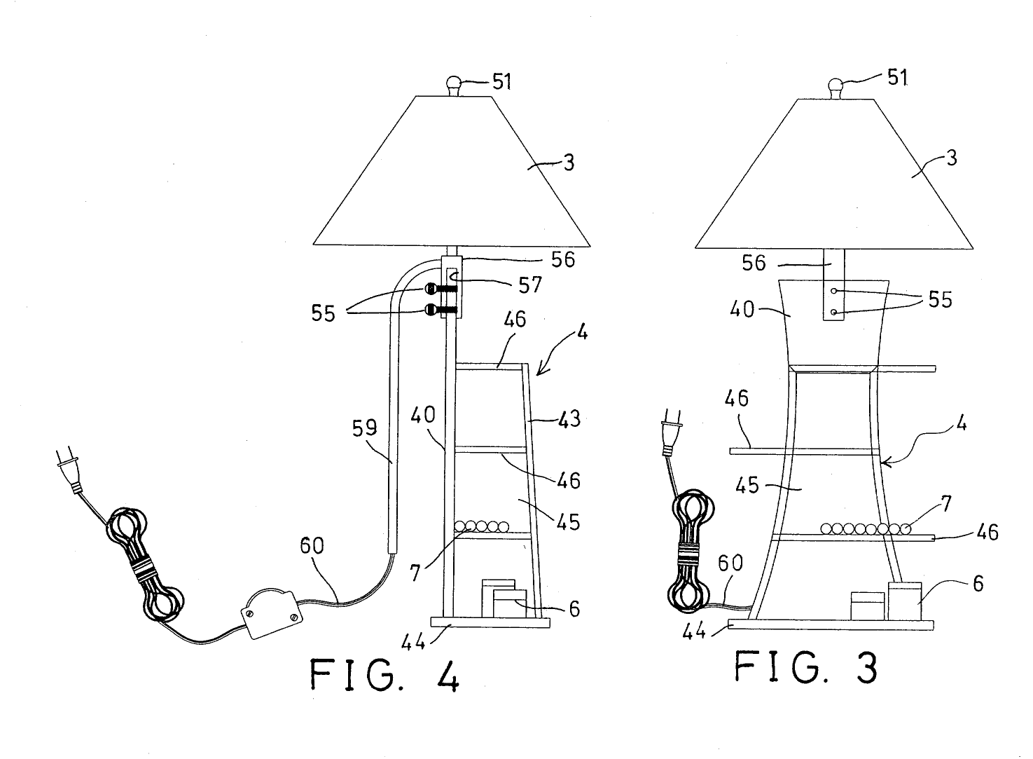

The housing 4 includes a rear wall 40 and a front wall 43 disposed on or extended up from a bottom panel 44, and spaced away from each other to form or define a space 45 between the walls 40, 43 and the bottom panel 44. One or more plates or shelves 46 are disposed within the space 45 of the housing 4, and secured between the rear and the front walls 40, 43, to support various objects 6, 7 (FIGS. 3, 4).

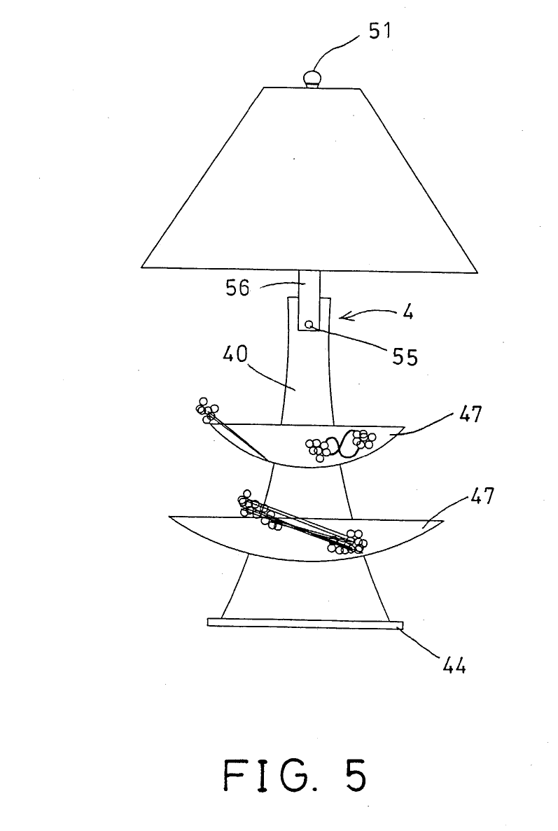

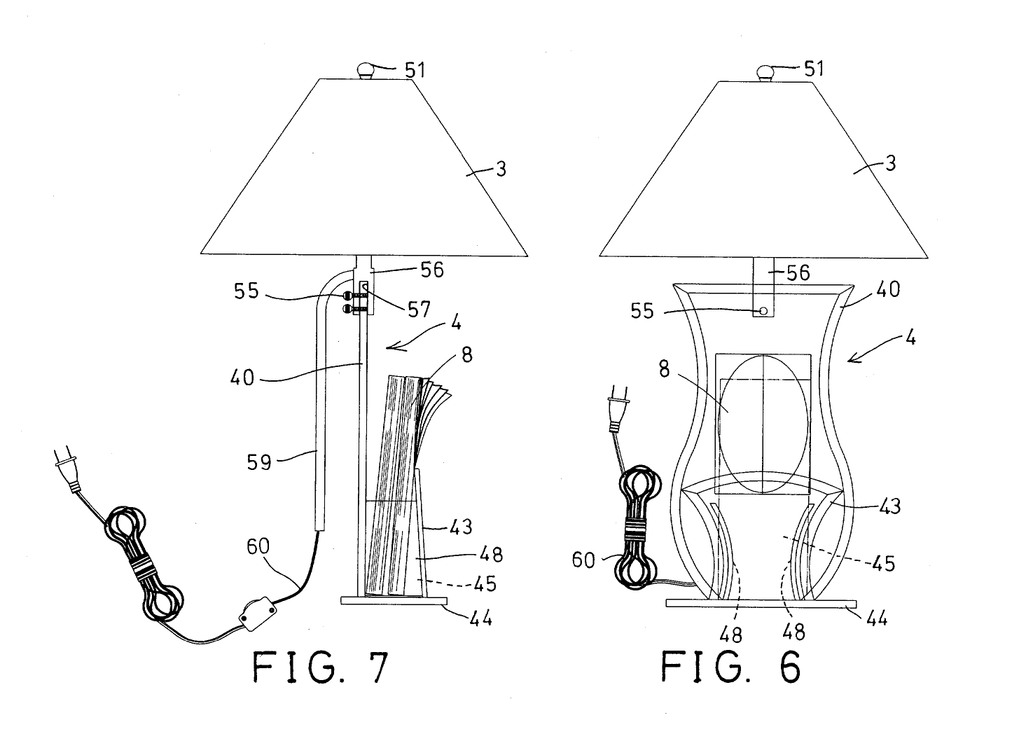

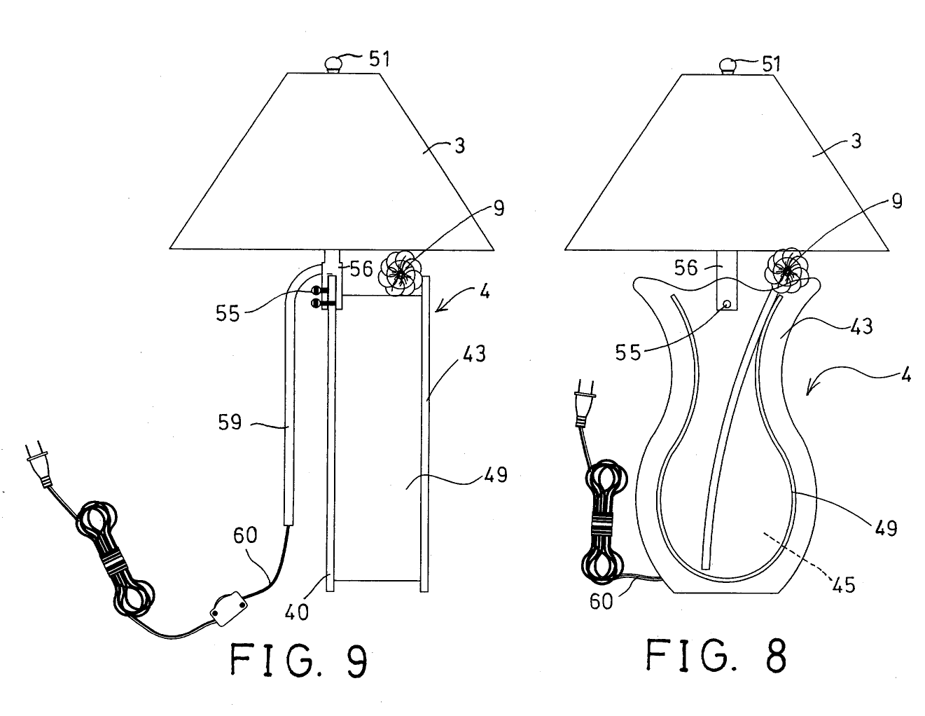

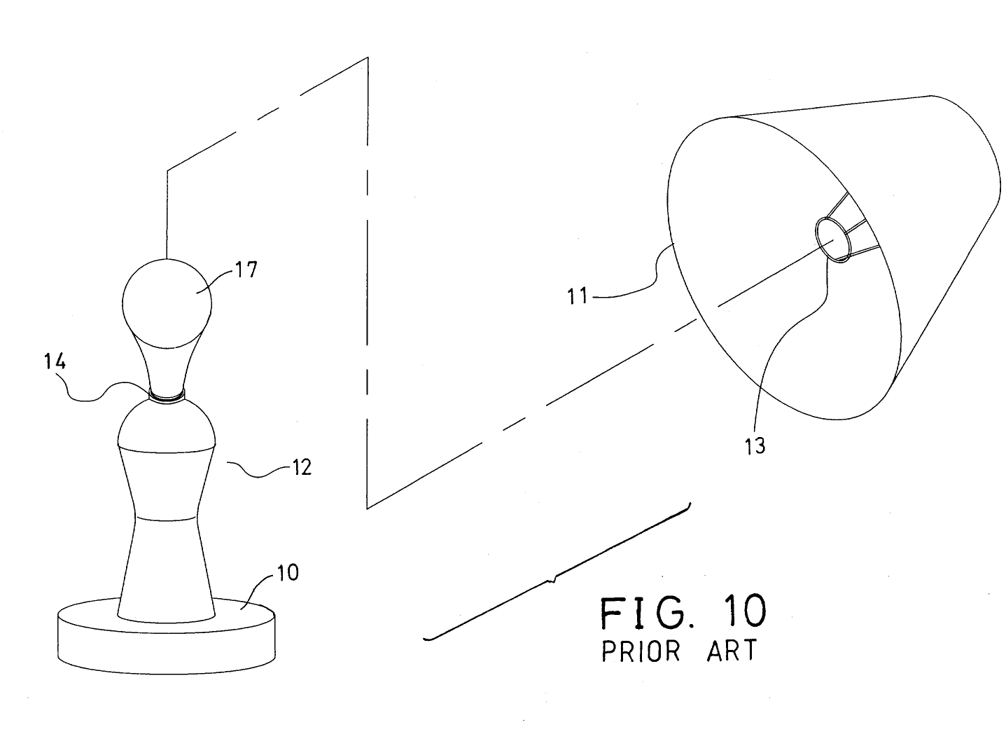

It is preferable that the rear wall 40 includes a height greater than that of the front wall 43, and includes one or more apertures 41 formed in the upper portion thereof. Alternatively, as shown in FIG. 5, one or more platters 47 may be attached to the rear wall 40 to support different objects. As shown in FIGS. 6-9, the housing 4 may be formed into various kinds of shapes or contours, and may include one or more side walls 48, 49 to form or define the space 45 in the housing 4, and to receive or support different or various objects 8, 9.

The support device 5 includes a bracket 56 having a groove 57 formed therein to receive the upper portion of the rear wall 40, and one or more fasteners 55 are engaged through the bracket 56 and engaged through the apertures 41 of the rear wall 40, for allowing the bracket 56 to be engaged onto and secured to the upper portion of the rear wall 40.

The support device 5 further includes a bar 50 secured on top of the bracket 56, and an inverted U-shaped frame 54 disposed and secured above the bar 50, and a socket 53 disposed on top of the middle portion of the bar 50 for receiving or plugging a light bulb or member 58, and a fastener 52 disposed on top of the frame 54, for engaging through the orifice 32 of the ring 31 of the spider 30. A lock nut 51 may be threaded to the fastener 52 and engaged with the ring 31 of the spider 30, to secure the lampshade 3 on top of the frame 54 of the support device 5.

The support device 5 may further include a tube 59 attached to or extended from the bracket 56, to receive one or more electric wires or cables 60 therein.

It is to be noted that the bracket 56 of the support device 5 may be detachably and selectively attached onto various kinds of housings 4 as shown in FIGS. 1-9, for supporting or receiving various kinds of objects therein. The housings 4 may be formed or shaped into various kinds of contours, for decorative purposes.

Accordingly, the light device in accordance with the present invention includes a housing for receiving or storing various objects therein.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A light device comprising:
a housing including a bottom panel, a rear wall extended up from said bottom panel, to define a space in said housing and to receive various objects in said space of said housing,
a support device including a bracket secured on top of said rear wall, a bar and a socket disposed on top of said bracket, a frame secured on said bar and including an upper portion having a fastener provided thereon,
a light member attached to said socket,
a lamp shade including an upper portion having a spider disposed therein and secured to said upper portion of said frame with said fastener.

2. The light device as claimed in claim 1, wherein said housing further includes a front wall extended up from said bottom panel, to define said space in said housing together with said rear wall.

3. The light device as claimed in claim 2, wherein said housing further includes at least one shelf disposed between said front wall and said rear wall, to receive the objects on said at least one shelf.

4. The light device as claimed in claim 1, wherein said spider of said lampshade includes a ring provided therein and having an orifice formed therein to receive said fastener.

5. The light device as claimed in claim 1, wherein said support device includes a lock nut threaded to said fastener and engaged with said ring to solidly secure said lamp shade on said frame.

6. The light device as claimed in claim 1, wherein said support device includes a tube attached to said bracket.
